(19) United States
(12) Patent Application Publication
(10) Pub. No.: US 2011/0230161 A1
(43) Pub. Date: Sep. 22, 2011

(54) Smartphone emergency alarm

(76) Inventor: Fredric Mark Newman, Santa Monica, CA (US)

(21) Appl. No.: 13/065,458

(22) Filed: Mar. 22, 2011

Related U.S. Application Data
(60) Provisional application No. 61/316,124, filed on Mar. 22, 2010.

(51) Int. Cl. H04M 11/04

(52) U.S. Cl. 455/404.1

(57) ABSTRACT

The current invention is an alarm phone device or an alarm system that turns a smart phone into a mobile emergency alarm. The alarm functions like a standard home alarm system in that it emits an audible alarm and contacts a centralized alarm company, which has the appropriate emergency personnel or first responders dispatched.

THIS APPLICATION CLAIMS BENEFIT OF THE PROVISIONAL patent application OF FRED NEWMAN, APPLICATION Ser. No. 61/316,124, FILED ON Mar. 22, 2010.

### BACKGROUND OF THE INVENTION

The current invention relates to alarm devices and systems. Specifically, it relates to an alarm system that turns a smart phone into a mobile emergency single point alarm. The alarm functions like a standard home alarm system in that it can emit an audible alarm and contacts a centralized alarm company, which has the appropriate emergency personnel dispatched.

Over 80% of all people living in the United States use mobile phones as a personal communication device. One of the advantages of having a mobile phone is that a person is able to call for help, such as dialing 9-1-1 in the event of an emergency. Unfortunately, dialing 9-1-1 during an emergency is not always effective because the user may not be able to talk or, if the user is about to be attacked, the attacker may prevent the user from completing the 9-1-1 call.

Many of the people with mobile phones have advanced phones called “smart phones.” Smart phones operate as phones, but they are also built with many additional features and they typically offer the ability to act like a mobile computer. Most smart phones have a user friendly graphical user interface and operating system. Smart phones typically have the ability to access email, the internet, business documents, and media files. Smart phones also usually include a miniature QWERTY keyboard, a touch screen, camera, accelerometer, global positioning system (“GPS”) navigation, and scroll keys.

Examples of smart phones include the iPhone® and the Blackberry®. Recently, the operating systems of the phones have allowed users to create programs, called “Applications” or “Apps”, that provide very specific functionality to the smart phones.

Despite the significant growth of applications available for smart phones, there is no Application that is specifically designed to contact a central alarm monitoring station in the event of an emergency with the user's information and the phone's GPS location in the event of an emergency.

Thus, there is a need in the art for a smart phone that can function as an emergency alarm.

### BRIEF SUMMARY OF THE INVENTION

One embodiment of the present invention is a mobile alarm phone comprising: a mobile phone; wherein the mobile phone comprises an alarm; and wherein the alarm is operated using the mobile phone controls. Preferably, the alarm transmits an alert to a central alarm monitoring station when the alarm is fired. The central alarm monitoring station has a first responder dispatched to a location of the mobile phone. Preferably, a user provides the alarm with a plurality of settings data. The alarm transmits the plurality of settings data to the central alarm monitoring station. The phone further comprises a global positioning system. The alarm preferably transmits the location of the mobile phone based on the global positioning system. The alarm preferably transmits an updated user location on a preset interval after it is fired. Preferably, the alarm emits an audible alarm. Alternatively, the alarm may be placed in silent mode. The alarm is activated by arming the alarm and then firing the alarm. Once armed, the alarm is fired by tapping an alarm button. The user may cancel a fired alarm or disarm an armed alarm. Optionally, the alarm may transmit live audio or video from the mobile phone or recorded audio or video from the mobile phone. Another option of the alarm phone is to transmit a photo of the user. Preferably, the alarm notifies the user if the phone is not connected to a network or otherwise has no signal or connectivity.

The invention is a mobile device, such as a smart phone that has a personal signal point alarm system. When the alarm is activated it sends alarm data, including information about the owner of the device and the user's GPS location, to a central alarm monitoring station. The central alarm monitoring station then has dispatched the appropriate help to the user, such as police or medical response. Additionally, the device also has a visible and audible alarm that alerts those in the surrounding area to the emergency. The device has safeguards against false alarms, test features for status of functionality, and notification, both visual and audible, of network connectivity status. The notification of network connectivity status also preferably alerts the user that the alarm cannot be used when the network is not connected.

It is an object of the present invention to provide a smart phone with a personal alarm.

Another object of the present invention is to provide a personal alarm that is connected to a central monitoring center.

Another object of the present invention is to provide a mobile phone personal alarm that overcomes the limitations of the prior art.

The personal phone alarm preferably serves to alert a central alarm monitoring station which then has the appropriate first responders dispatched. Preferably, the central alarm monitoring station is an alarm company and the owner of the alarm phone device subscribes to the alarm response service.

The device is preferably a mobile smart phone with special software, or an application, which allows the phone to function as a personal alarm.

### BRIEF DESCRIPTION OF THE SEVERAL VIEWS OF THE DRAWINGS

FIG. 1 is a screen shot of the mobile phone display of one embodiment of the invention and shows the Arm, Test, Location Notes, Settings, Auto-Arm screen

FIG. 2 is a screen shot of the mobile phone display of one embodiment of the invention and shows a section of the Help screen for the Arm, Test, Location Notes, Settings, Auto-Arm screen.

FIG. 3 is a screen shot of the mobile phone display of one embodiment of the invention and shows the Settings menu.

FIG. 4 is a screen shot of the mobile phone display of one embodiment of the invention and shows the Application settings menu.

FIG. 5 is a screen shot of the mobile phone display of one embodiment of the invention and shows the Logout screen.

FIG. 6 is a screen shot of the mobile phone display of one embodiment of the invention and shows the Login menu.

FIG. 7 is a screen shot of the mobile phone display of one embodiment of the invention and shows the Contact screen.

FIG. 8 is a screen shot of the mobile phone display of one embodiment of the invention and shows the Take Photo, Choose Existing Photo, Delete Photo screen.

FIG. 9 is a screen shot of the mobile phone display of one embodiment of the invention and shows the Emergency information screen.

FIG. 10 is a screen shot of the mobile phone display of one embodiment of the invention and shows the Billing screen.

FIG. 11 is a screen shot of the mobile phone display of one embodiment of the invention and shows the Location Notes screen.

FIG. 12 is a screen shot of the mobile phone display of one embodiment of the invention and shows the Test screen.

FIG. 13 is a screen shot of the mobile phone display of one embodiment of the invention and shows the Testing GPS Services animation screen.

FIG. 14 is a screen shot of the mobile phone display of one embodiment of the invention and shows the Testing Network Access animation screen.

FIG. 15 is a screen shot of the mobile phone display of one embodiment of the invention and shows the Testing Server Connection animation screen.

FIG. 16 is a screen shot of the mobile phone display of one embodiment of the invention and shows the Testing Central Monitoring animation screen.

FIG. 17 is a screen shot of the mobile phone display of one embodiment of the invention and shows the Test Successful screen.

FIG. 18 is a screen shot of the mobile phone display of one embodiment of the invention and shows the Arm screen.

FIG. 19 is a screen shot of the mobile phone display of one embodiment of the invention and shows the Arm screen with Siren On/Off switch in the Siren Off position.

FIG. 20 is a screen shot of the mobile phone display of one embodiment of the invention and shows the following message: Authorization Error You entered an incorrect password. The system is not armed. Please try Again. OK

FIG. 21 is a screen shot of the mobile phone display of one embodiment of the invention and shows the ENTER PASSWORD TO CANCEL screen.

FIG. 22 is a screen shot of the mobile phone display on one embodiment of the invention and shows the following message: Cancelled The Panic Alarm has been successfully cancelled.

FIG. 23 is a screen shot of the mobile phone display on one embodiment of the invention and shows the PANIC ALARM SENT screen.

FIG. 24 is a screen shot of the mobile phone display on one embodiment of the invention and shows the PANIC ALARM ARMED screen with the network icon to the right of the volume slider in the “no network” notification configuration with animation ceased.

FIG. 25 is a screen shot of the mobile phone display of one embodiment of the invention and shows the MEDICAL ALERT ARMED screen.

FIG. 26 is a screen shot of the mobile phone display of one embodiment of the invention and shows the medical alert ENTER PASSWORD TO CANCEL screen.

FIG. 27 is a screen shot of the mobile phone display of one embodiment of the invention and shows the MEDICAL ALERT SENT screen.

FIG. 28 is a screen shot of the mobile phone display of one embodiment of the invention and shows the medical alert Application Settings, Login, Contact, Emergency, Medical, Billing screen.

FIG. 29 is a screen shot of the mobile phone display of one embodiment of the invention and shows the medical alert alarm Medical information screen.

FIG. 30 is a screen shot of the mobile phone display of one embodiment of the invention and shows the panic alarm and medical alert alarm combined Arm screen.

FIG. 31 is a screen shot of the mobile phone display of one embodiment of the invention and shows the combined panic alarm and medical alert Arm, Test, Location Notes, Settings, and Auto-Arm screen.

FIG. 32 is a screen shot of the mobile phone display of one embodiment of the invention and shows the combined panic alarm and medical alert Test screen.

FIG. 33 is a screen shot of the mobile phone display of one embodiment of the invention and shows the Reset Password button.

FIG. 34 is a screen shot of the mobile phone display of one embodiment of the invention and shows the Reset Password screen.

### DETAILED DESCRIPTION OF THE INVENTION

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

The embodiment shown in these figures depicts the mobile phone alarm device as an iPhone® with an alarm application. It should be understood that this invention may be practiced with any cellular phone, mobile phone, or smart phone.

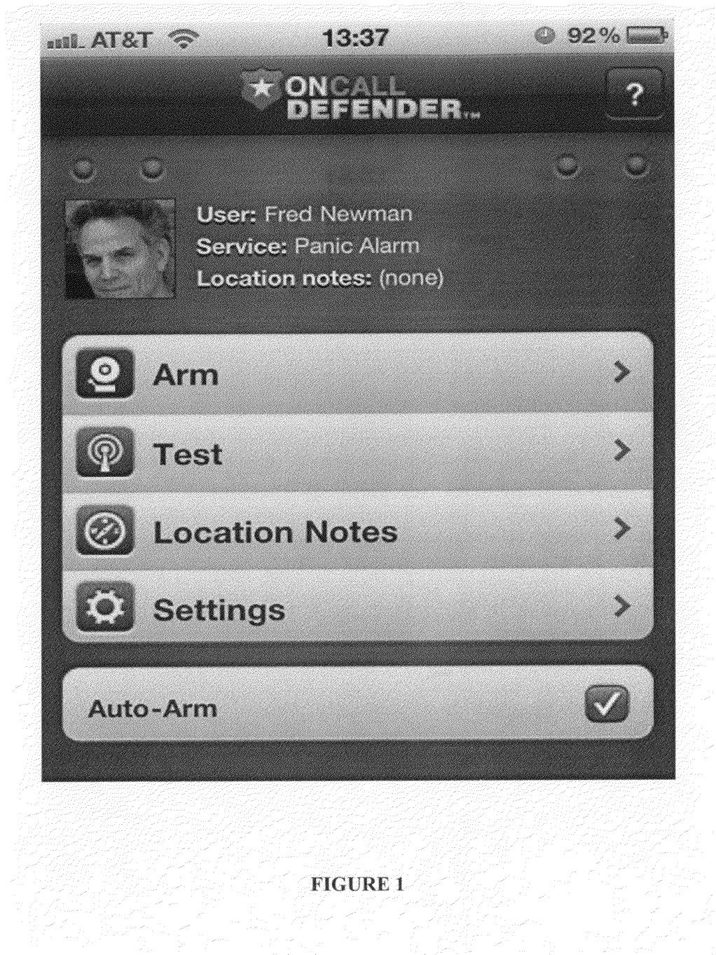

FIG. 1 is a screen shot of the mobile phone display of one embodiment of the invention and shows the Arm, Test, Location Notes, Settings, Auto-Arm screen. This screen preferably allows the user to select Arm, Test, Location Notes, Settings or set Auto-Arm by pressing the appropriate button.

Pressing the ? button on the Arm, Test, Location Notes, Settings, Auto-Arm screen opens the Help screen.

When pressed, buttons identified on the application screens with ? open Help screens with descriptions of the operation of the specific screen functions.

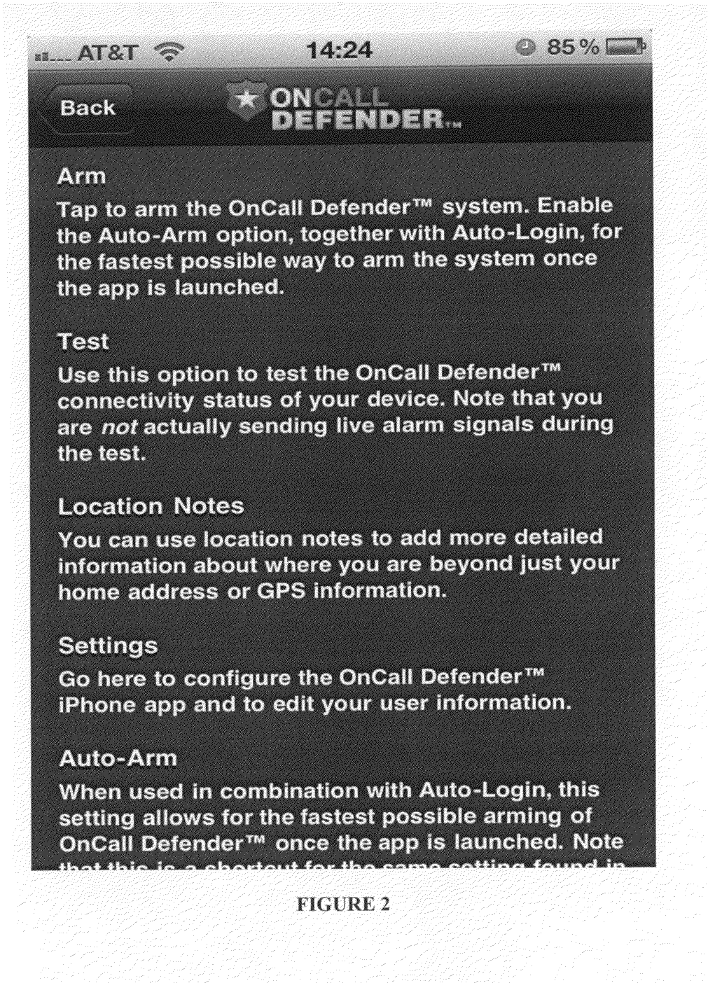

FIG. 2 is a screen shot of the mobile phone display of one embodiment of the invention and shows a section of the Help screen for the Arm, Test, Location Notes, Settings, Auto-Arm screen.

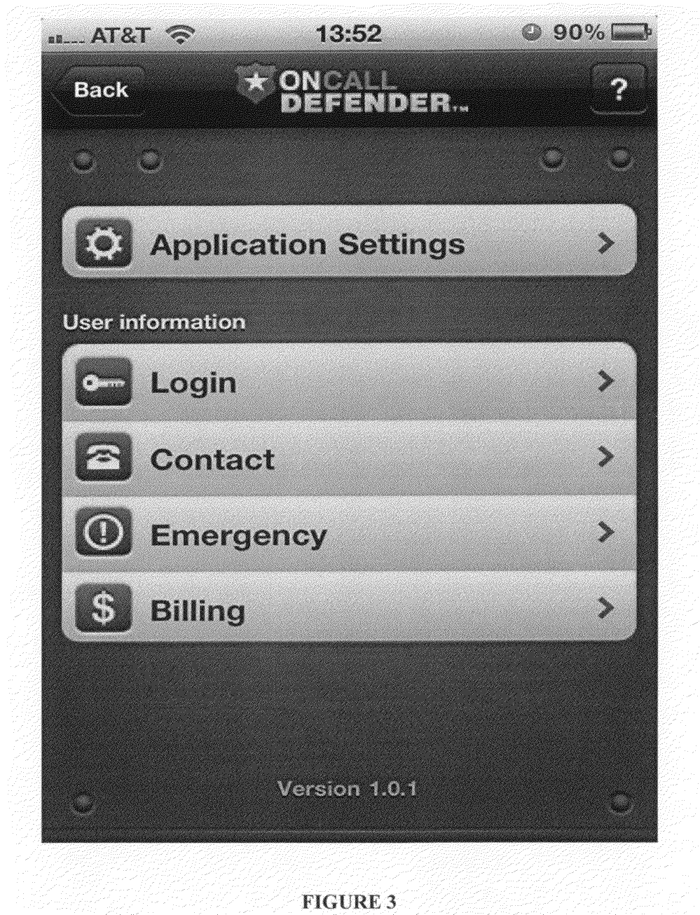

FIG. 3 is a screen shot of the mobile phone display of one embodiment of the invention and shows the Settings menu. Pressing the Settings button in the Arm, Test, Location Notes, Settings, Auto-Arm screen preferably opens the Settings menu or window. The Settings menu preferably allows the user to select Application Settings, Login, Contact, Emergency, Billing.

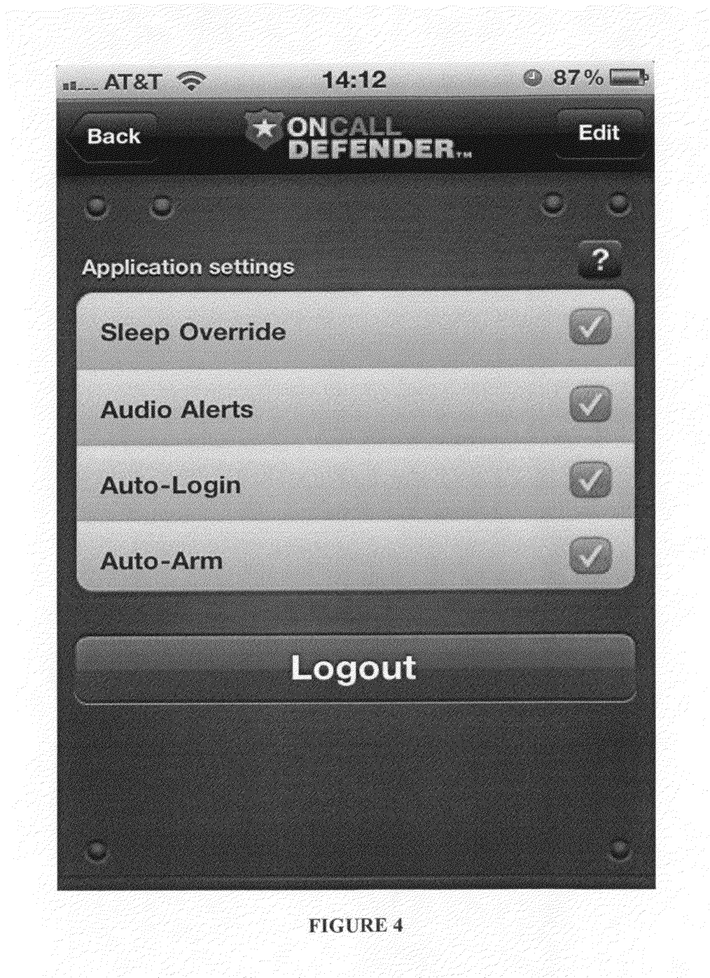

FIG. 4 is a screen shot of the mobile phone display of one embodiment of the invention and shows the Application settings menu. Pressing the Applications Setting button in the Applications Settings, Login, Contact, Emergency, Billing screen opens the Application Settings menu or window. The Application settings menu preferably has four user changeable on/off buttons, Sleep Override, Audio Alerts, Auto-Login, Auto-Arm, and a Logout button.

Pressing the Sleep Override button on, indicated by a check mark, overrides the auto-lock screen-off timer function of the phone, keeping the screen on continuously. The phone can be set to screen-off Auto-Lock at a specific time, such as at 1, 2, 3, 4, or 5 minutes. When the phone auto-locks, the screen goes blank. The user may set the alarm to override the Auto-Lock feature, so that the screen does not go blank. In the absence of such an override, the user may arm the device and when the user needs to fire the alarm, the user is forced to press the iPhone® home button, then activate the “slide to unlock” feature to bring the arm screen back into view.

Pressing the Audio-Alerts button on, indicated by a check mark, allows audio alerts, such as a network connection failure, to play.

Pressing the Auto-Login button on, indicated by a check mark, by-passes the login function of the app.

Pressing the Auto-Arm button on, indicated by a check mark, arms the alarm when the application is turned on, without the need for entering a password, provided the Auto-Login function is turned on. If the Auto-Login function is turned off, and Auto-Arm is turned on, when the application is turned on and the password is entered, the alarm will automatically arm.

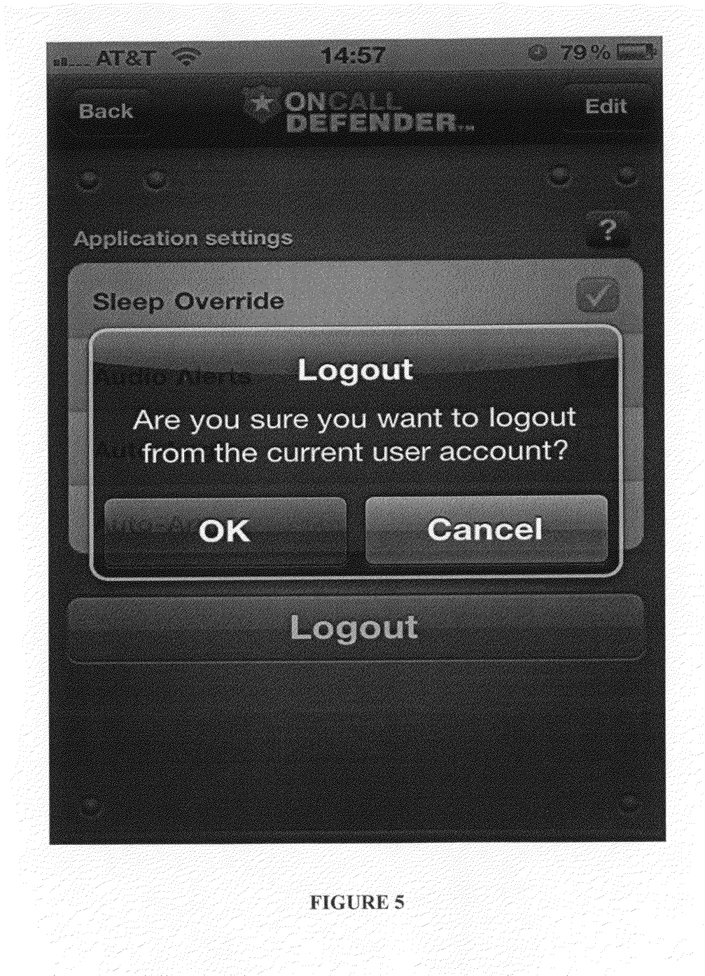

FIG. 5 is a screen shot of the mobile phone display of one embodiment of the invention and shows the Logout screen. This is the screen that appears when the Logout button is pressed on the Application settings screen. As shown in FIG. 5, the following message appears on screen:
Logout
Are you sure you want to logout from the current user account?
OK Cancel

When OK is pressed on the Logout screen, the application closes. When Cancel is pressed on the Logout screen, the user is taken back to the Application settings screen.

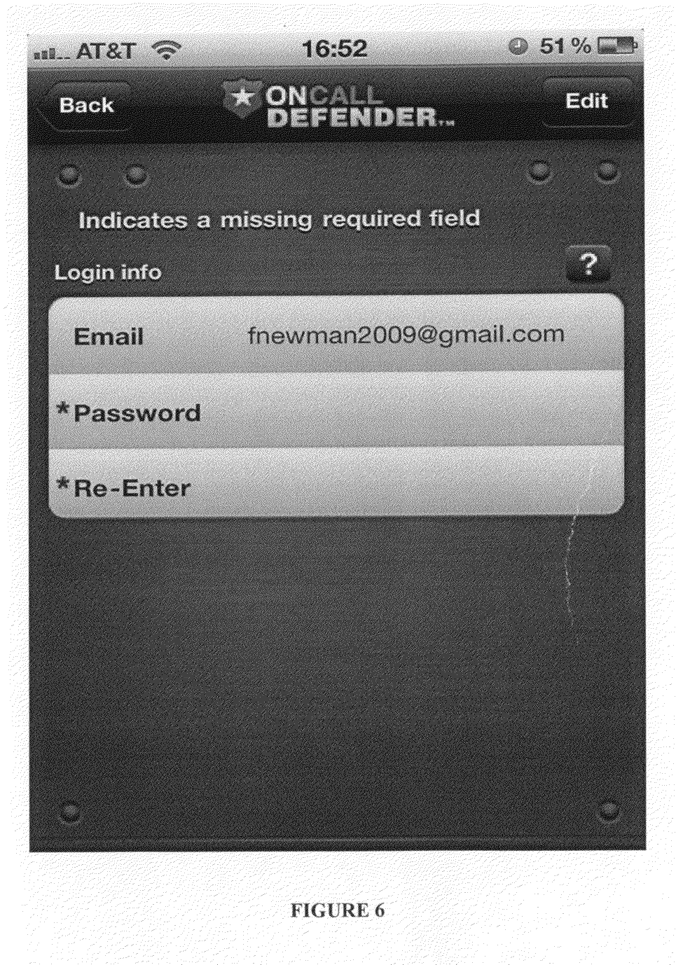

FIG. 6 is a screen shot of the mobile phone display of one embodiment of the invention and shows the Login menu. The Login menu preferably allows changing password by entering a new password in the field labeled Password, then entering the new password a second time in the field labeled Re-Enter. A red asterisk indicates a missing required field.

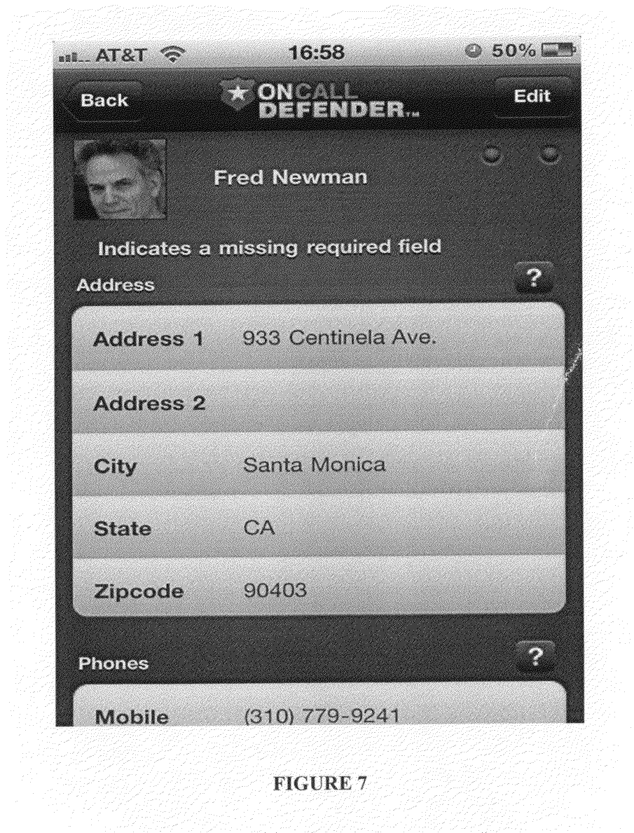

FIG. 7 is a screen shot of the mobile phone display of one embodiment of the invention and shows the Contact screen. The Contact screen includes multiple sections of fields to be filled in by the user. The contact information fields allow the user to enter the user's name and address. If the user scrolls the screen down, the user may also enter the city, state, and zip code as well as Mobile, Home and Work phone numbers, and miscellaneous information including Gender and Birthdate.

A photograph of the user can also be loaded to the settings data, taken with the phone or loaded from an existing photo in the phone's photo archive. This photo may be sent, along with all other settings data, to the central alarm monitoring station. The photo can be supplied to the responding police force for assistance in responding to or following up on the criminal incident. It also may come in handy for helping the police not to arrest the wrong party.

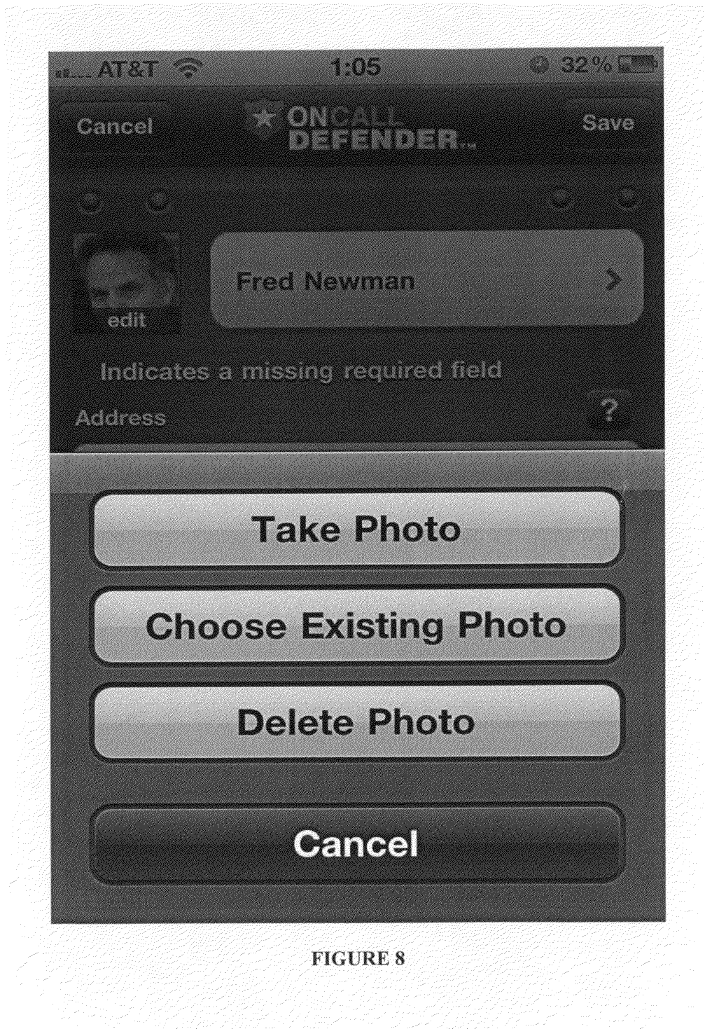

FIG. 8 is a screen shot of the mobile phone display of one embodiment of the invention and shows the Take Photo, Choose Existing Photo, Delete Photo screen.

In FIG. 7 showing the Contact screen, an asterisk indicates a required field. Preferably, the information in the Contact menu fields are sent to a central alarm monitoring station upon firing the alarm. Preferably, the user is required to fill in at least one phone number and a complete address. If a required field is not filled in, upon pressing the Done button to return to the Application Settings, Login, Contact, Emergency, Billing screen, the user is preferably not allowed out of the Contact screen.

When a required field is not filled in on the Contact screen, an Input Error message appears on screen indicating the required filed that must be filled in and the message:
Please enter a valid value.

Upon pressing the OK button, the message clears and takes the user back to the Contact screen.

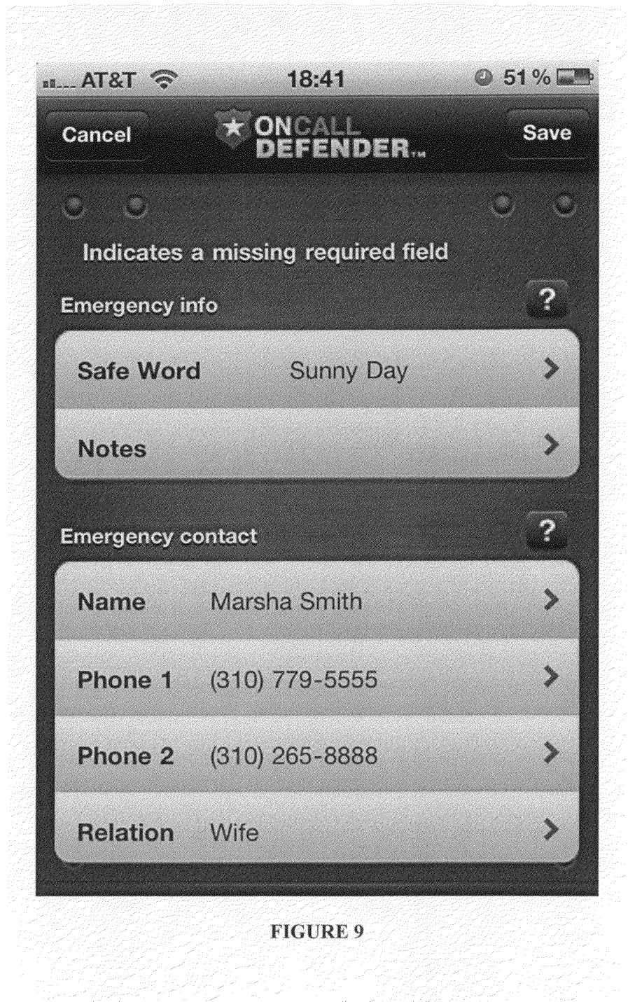

FIG. 9 is a screen shot of the mobile phone display of one embodiment of the invention and shows the Emergency information screen.

The Emergency information screen includes multiple sections of fields to be filled in by the user. The included Emergency information fields allow the user to enter a Safe Word. The Safe Word is a default code in the event of a false alarm. Specifically, the user can provide that Safe Word to the central alarm monitoring station as a confirmation that the user does not need assistance and has sent a false alarm. The Safe Word is also part of the information sent by the phone to the central alarm monitoring station. This way the central alarm monitoring station can verify that the user is providing the correct Safe Word.

The Emergency information fields allow the user to enter notes in the Notes field. This can include such information as restraining orders.

The Emergency screen includes Emergency contact fields which allow the user to enter emergency contact information, including name, phone numbers and relation.

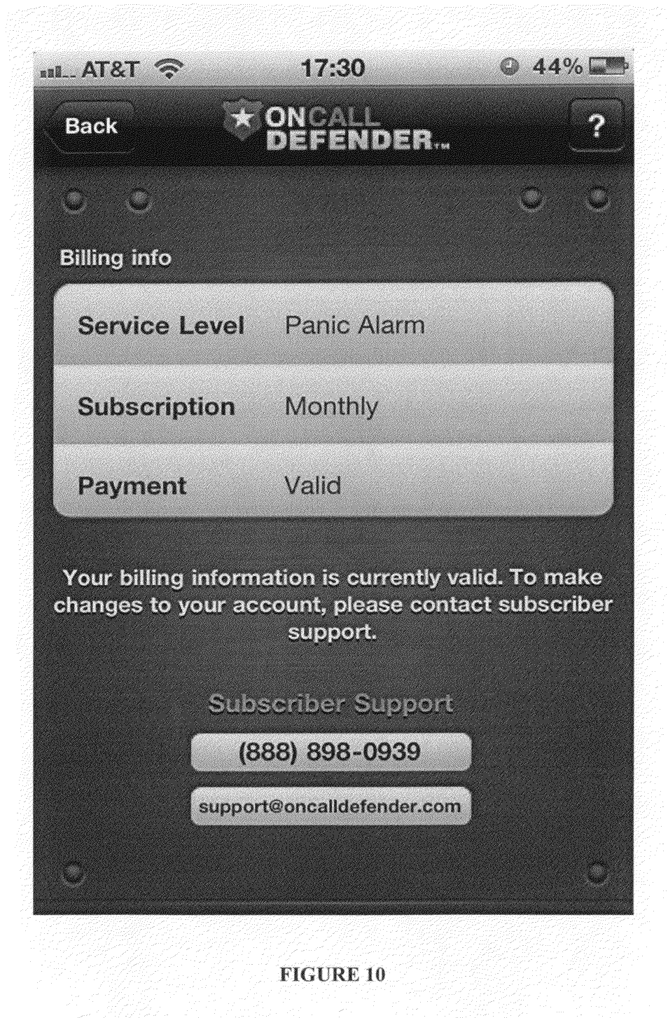

FIG. 10 is a screen shot of the mobile phone display of one embodiment of the invention and shows the Billing screen.

The Billing screen shows billing information, including Service Level, Subscription and Payment status.

The Billing screen has a Subscriber Support button that when pressed automatically calls a subscriber support line for assistance, as well as a support email address.

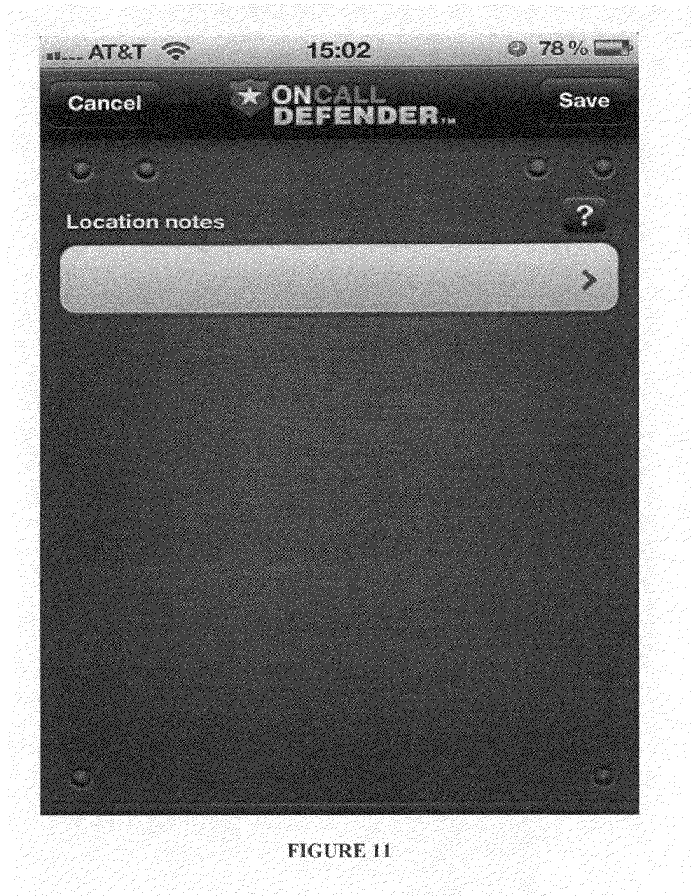

FIG. 11 is a screen shot of the mobile phone display of one embodiment of the invention and shows the Location Notes screen. The Location Notes screen allows the user to enter a location other than the user's home address, such as the building or apartment floor and unit the user is in. This information is transmitted if an alarm or medical alert is sent, allowing the police or medical response team to know where the user is within a building.

Location Notes are adjunct to the GPS generated address information sent to the monitoring station in the event of a panic alarm or medical alert, giving supplementary information to those responding so that they can find the user in a building with a number of offices, apartments, or other units. The information is saved, allowing ease of use at a future time without necessitating re-entry of the information.

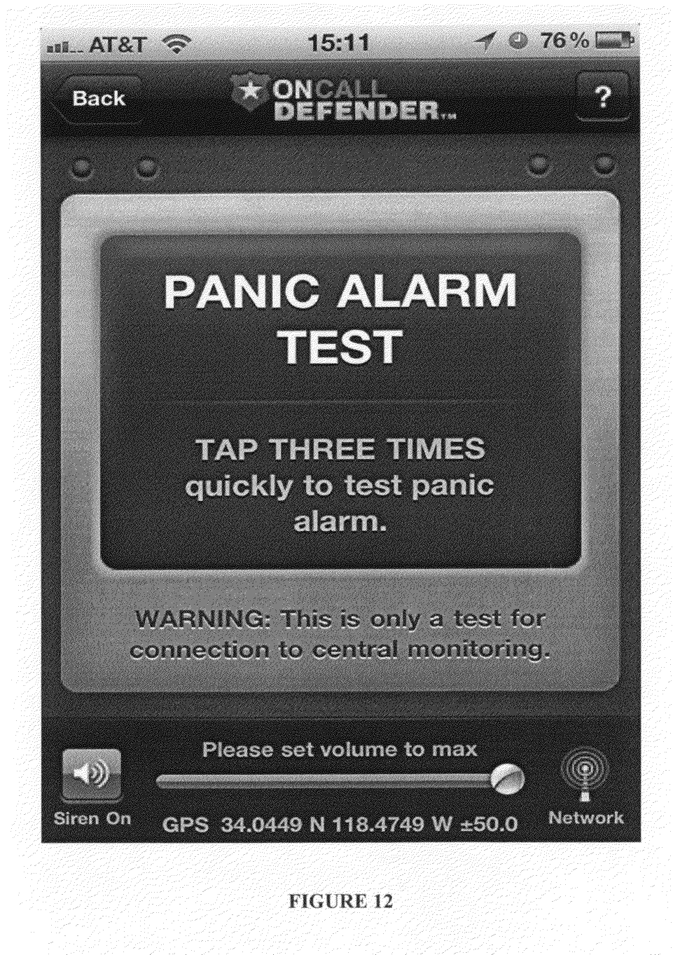

FIG. 12 is a screen shot of the mobile phone display of one embodiment of the invention and shows the Test screen. As shown in FIG. 12, preferably tapping the PANIC ALARM TEST button three times quickly sets off the audible alarm siren. As an aid to avoiding false alarms, the second and third taps must each be carried out within a pre-programmed time window. If the time window expires without tapping, the 3 tap sequence must begin again.

Upon tapping the PANIC ALARM TEST button once, the button darkens. Upon tapping the PANIC ALARM TEST button the second time, the button darkens further.

Upon tapping the PANIC ALARM TEST button three times quickly within the programmed time window, a test sequence commences.

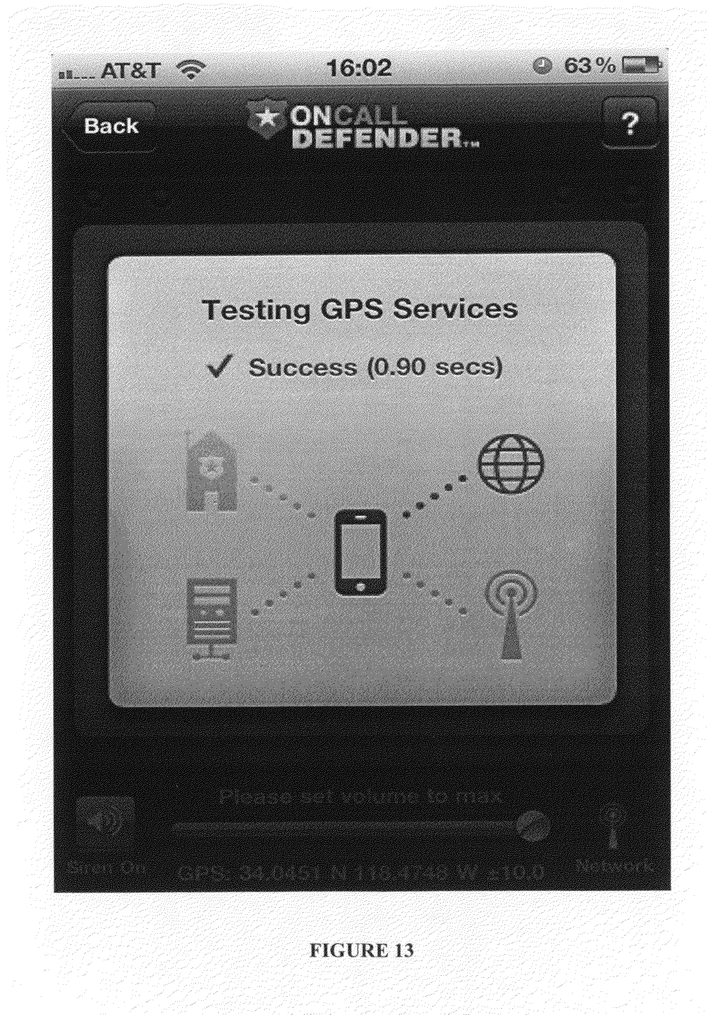

FIG. 13 is a screen shot of the mobile phone display of one embodiment of the invention and shows the Testing GPS Services animation screen.

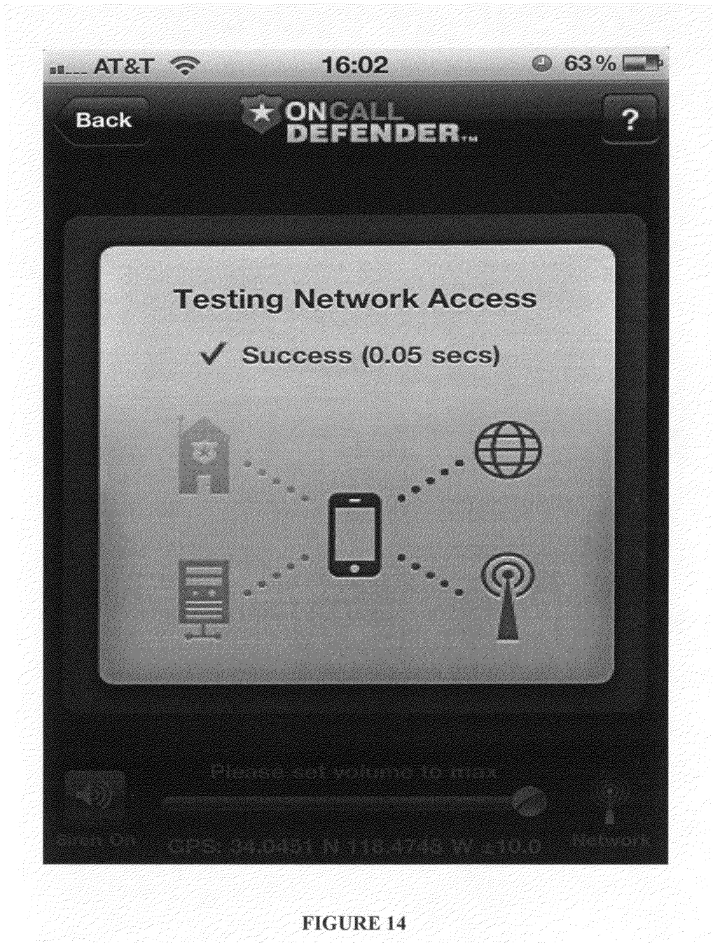

FIG. 14 is a screen shot of the mobile phone display of one embodiment of the invention and shows the Testing Network Access animation screen.

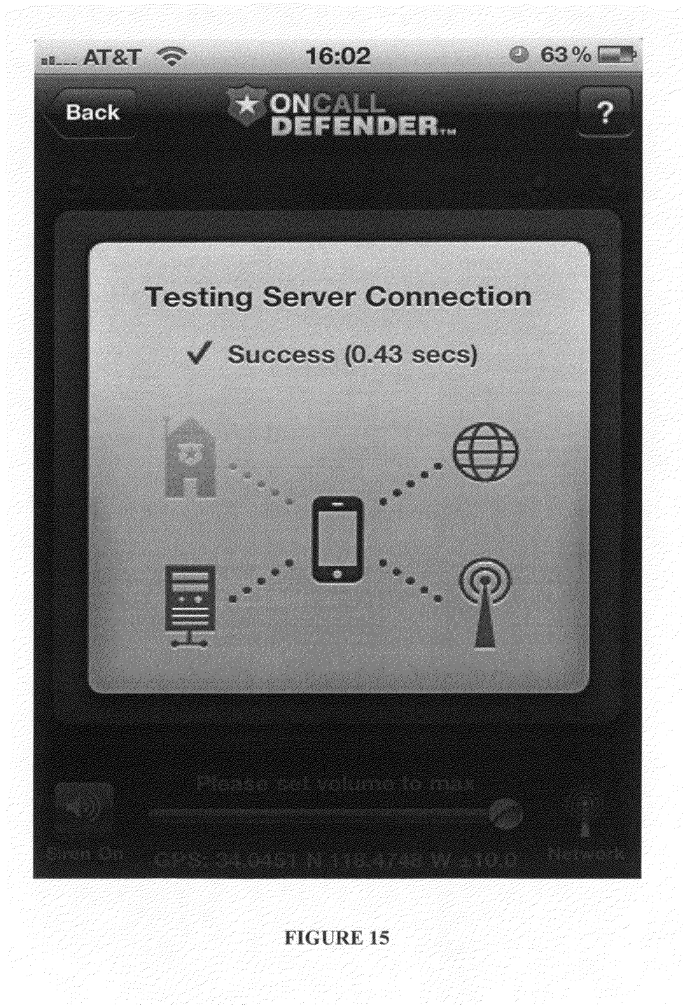

FIG. 15 is a screen shot of the mobile phone display of one embodiment of the invention and shows the Testing Server Connection animation screen.

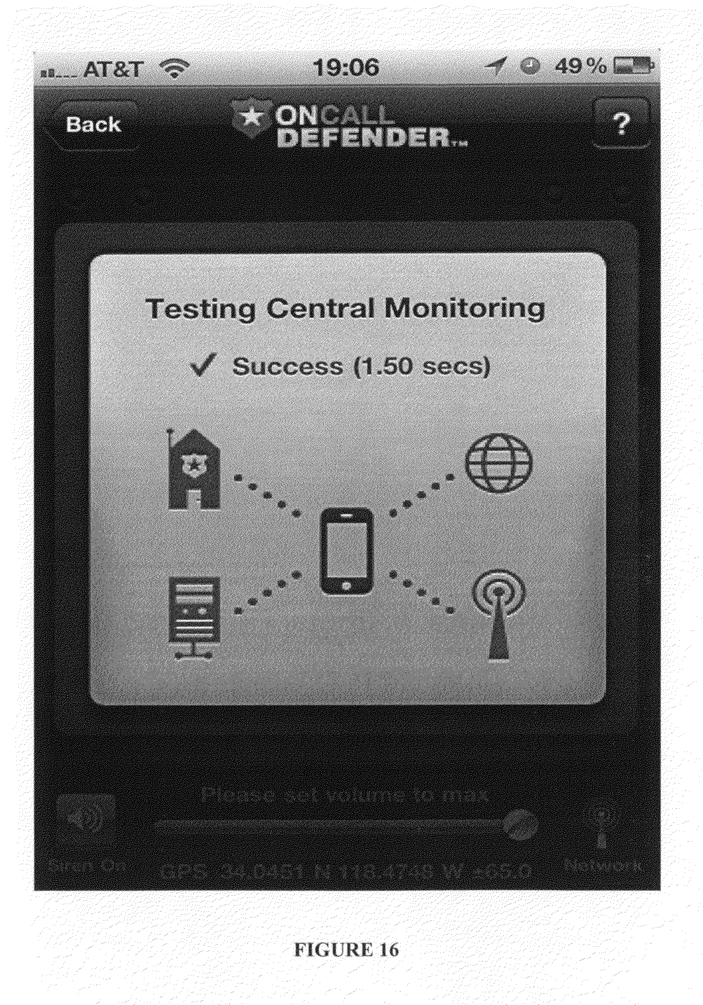

FIG. 16 is a screen shot of the mobile phone display of one embodiment of the invention and shows the Testing Central Monitoring animation screen.

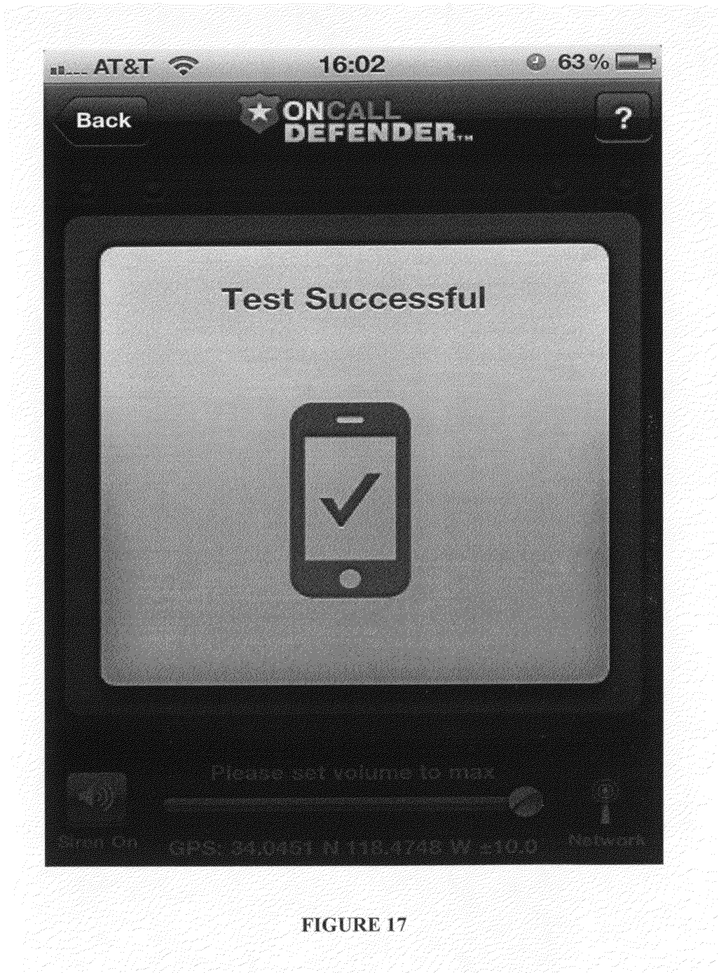

FIG. 17 is a screen shot of the mobile phone display of one embodiment of the invention and shows the Test Successful screen.

If one of the four tests is not successful, a Test Failed screen appears.

The panic alarm test function allows the user to practice firing the alarm. It utilizes the same firing methodology as the armed alarm.

As shown in FIG. 12, the following message appears on the Test screen to discourage false alarms:
WARNING: This is only a test for connection to central monitoring.

The Test screen also allows the user to ensure the volume of the alarm is turned up all the way using a volume slider. Preferably, the alarm device reminds the user to turn up the volume. The alarm default is maximum volume. As shown in FIG. 12, above the volume slider is the message, “Please set the volume to max.”

As shown in FIG. 12, the Test screen includes a Network animation, which expands and contracts when the data network is connected.

As shown in FIG. 12, the Test screen includes the GPS location and strength information located below the volume slider.

As shown in FIG. 12, the Test screen includes a siren On/Off control to the left of the volume slider. Tapping the slider On/Off control toggles between siren On and Off. Siren Off is identified by a circle and slash over the speaker icon.

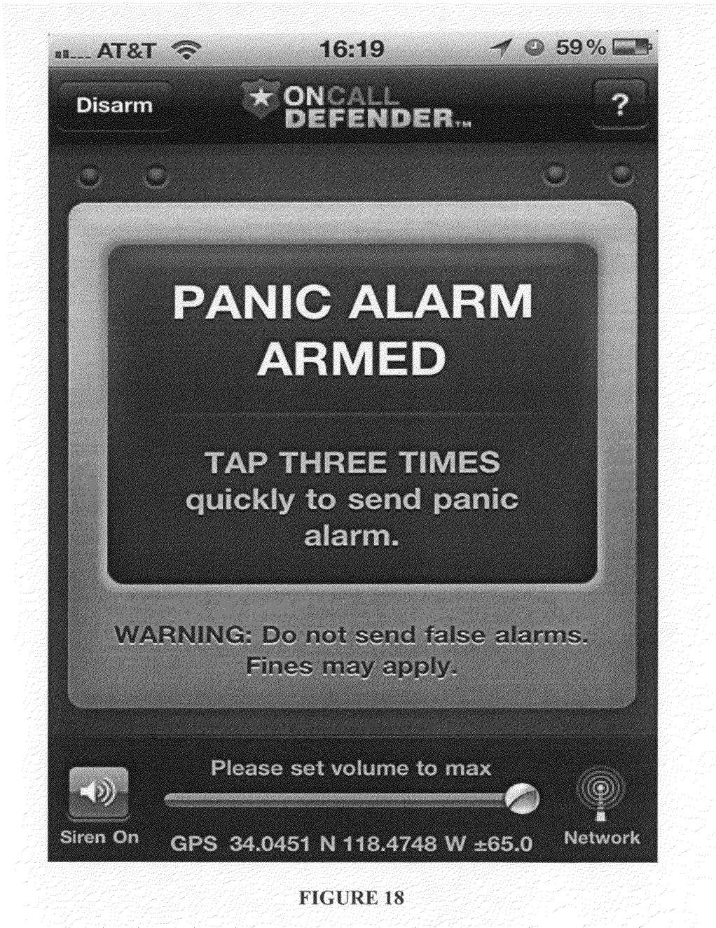

FIG. 18 is a screen shot of the mobile phone display of one embodiment of the invention and shows the Arm screen. When Auto-Arm is on, indicated by a check mark in the Auto-Arm button, pressing the Arm button on the Arm, Test, Location Notes, Settings, Auto-Arm screen arms the alarm and opens the Arm window or screen. When Auto-Arm is not on, indicated by an empty space in the Auto-Arm button, the Enter password to arm Panic Alarm screen opens. Entering the user password arms the alarm and opens the Arm screen.

When Auto-Arm is on, indicated by a check mark in the Auto-Arm button, preferably pressing the alarm icon on the phone's home screen automatically arms the alarm.

As shown in FIG. 18, preferably tapping the PANIC ALARM ARMED button three times quickly sends the alarm.

Preferably tapping the PANIC ALARM ARMED button three times quickly also sets off the audible alarm siren. As an aid to avoiding false alarms, the second and third taps must be preferably carried out within a programmed time window. (Any time duration may be programmed in.) If the time window expires without tapping, the 3 tap sequence must begin again to fire the alarm.

Upon tapping the PANIC ALARM ARMED button once, the button darkens. Upon tapping the PANIC ALARM ALARMED button the second time within the programmed time window, the button darkens further.

Once the alarm is fired the alarm data entered in the application settings is sent to a central alarm monitoring station along with the devices global positioning system (GPS) location in both map form and in latitude and longitude coordinates. The alarm then tracks the position of the device and sends that position to the alarm monitoring station on a set interval according to the pre-programmed duration. If the alarm is set for an audible alarm, or Siren On position, as well, a siren, or audible alarm is activated. If the alarm is set on silent, or Siren Off, then no siren is activated.

The alarm transmission is connected through to the central alarm monitoring station through the typical wireless means, including, but not limited to voice transmission, SMS for text messaging, email, packet switching for access to the Internet, Bluetooth, infrared, and/or satellite. Although the alarm phone preferably connects through a 3 G (wideband) or 4 G (broadband) network, the alarm phone may also use an 1 G (analog) or 2 G (digital) network.

The owner of the phone preferably subscribes to an alarm service that provides the dispatch and monitoring services. The primary purpose of the subscriber service is to ensure that once an alarm is fired the appropriate first responder is dispatched to the location of the phone, even if the phone is on the move.

As shown in FIG. 18, the following message appears on the Arm screen to discourage false alarms:
WARNING: Do not send false alarms. Fines may apply.

The Arm screen also allows the user to ensure the volume of the alarm is turned up all the way. Preferably, the alarm device reminds the user to turn up the volume. The alarm default is maximum volume. As shown in FIG. 18, above the volume slider is the message, “Please set the volume to max.”

As shown in FIG. 18, the Arm screen includes a Network animation, which expands and contracts when the data network is connected.

As shown in FIG. 18, the Arm screen includes the GPS location and strength information located below the volume slider.

As shown in FIG. 18, the Arm screen includes a siren On/Off control to the left of the volume slider. Tapping the siren On/Off control toggles between Siren On and Siren Off. Siren Off is identified by a circle and slash over the speaker icon.

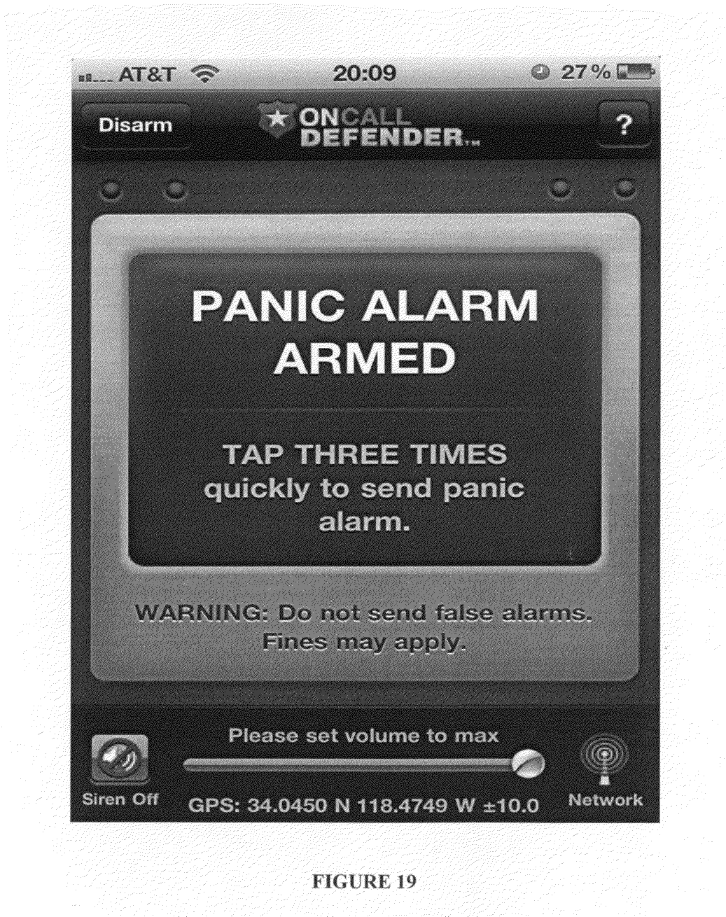

FIG. 19 is a screen shot of the mobile phone display of one embodiment of the invention and shows the alarm Siren On/Off switch in the Siren Off position.

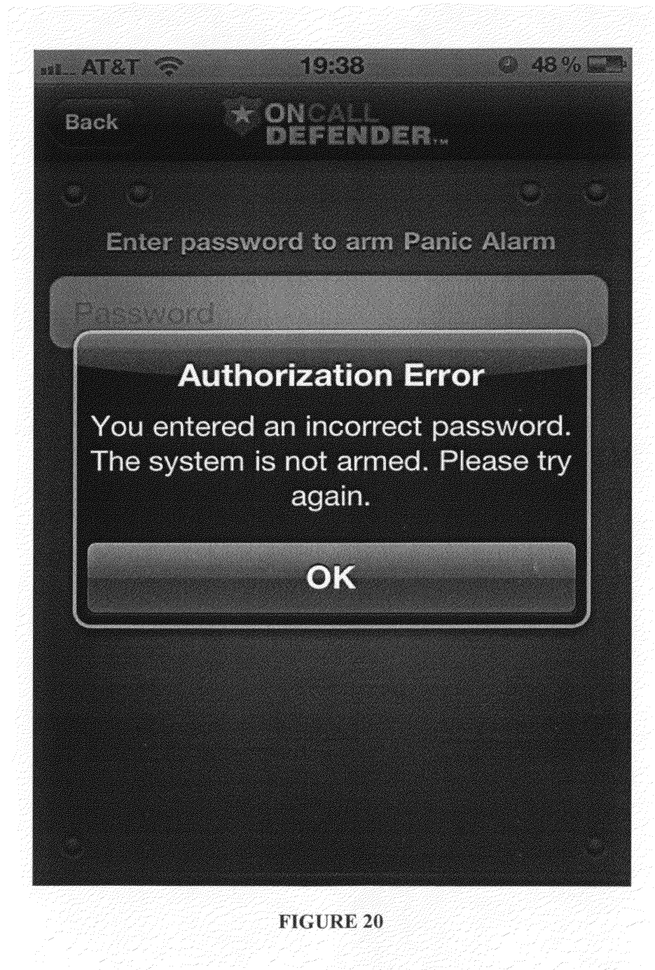

FIG. 20 is a screen shot of the mobile phone display of one embodiment of the invention and shows the following message:
Authorization Error
You entered an incorrect password.
The system is not armed. Please try
   Again.
      OK
         This message screen appears if an incorrect password is entered when arming the alarm. Upon pressing OK, the message clears and takes the user back to the Enter password to arm Panic Alarm screen.

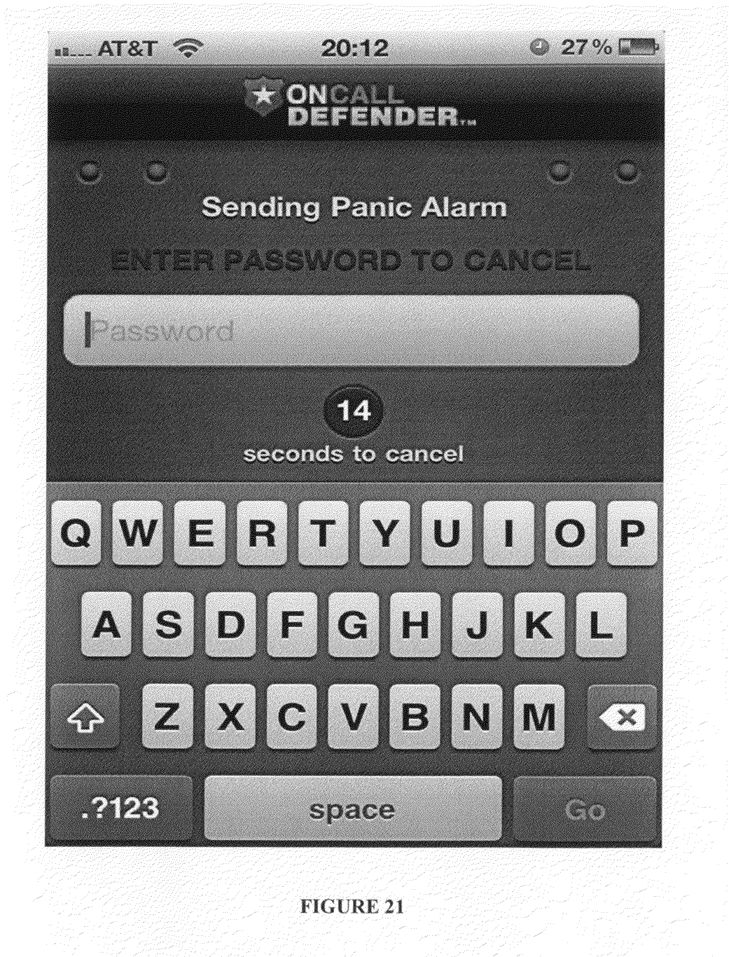

FIG. 21 is a screen shot of the mobile phone display of one embodiment of the invention and shows the ENTER PASSWORD TO CANCEL screen. This screen appears when an alarm is sent.

A countdown timer, preferably 15 seconds, located on the ENTER PASSWORD TO CANCEL screen, shows the number of seconds left to cancel an alarm. If the user's password is entered before the countdown timer reaches zero, the alarm is canceled.

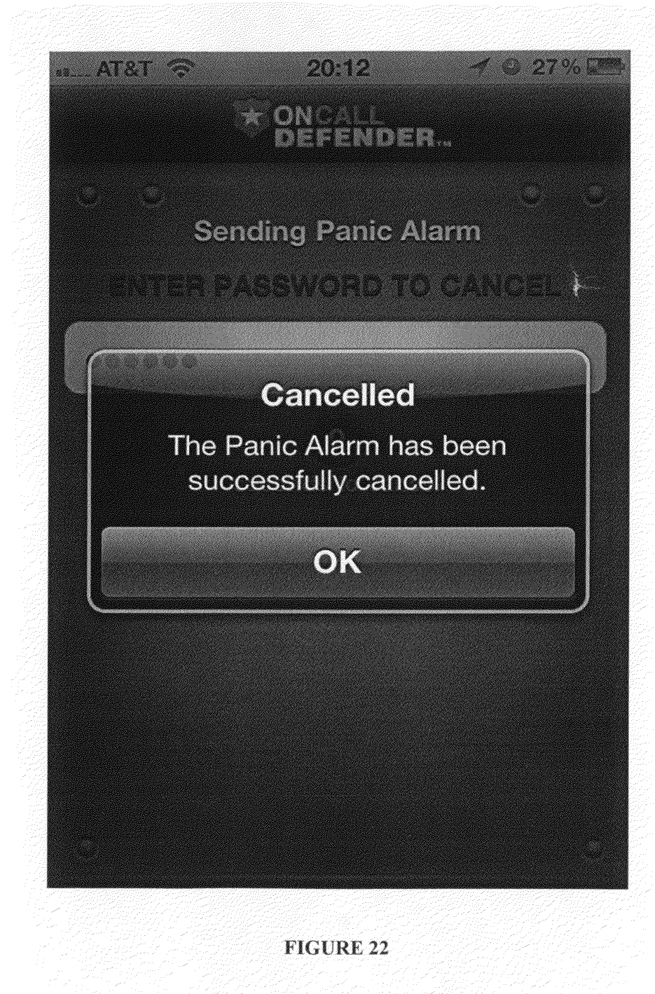

FIG. 22 is a screen shot of the mobile phone display on one embodiment of the invention and shows the following message:
Cancelled
The Panic Alarm has been successfully cancelled.

The message in FIG. 22 is displayed when an alarm is cancelled within the 15 second countdown that commences when an alarm is fired.

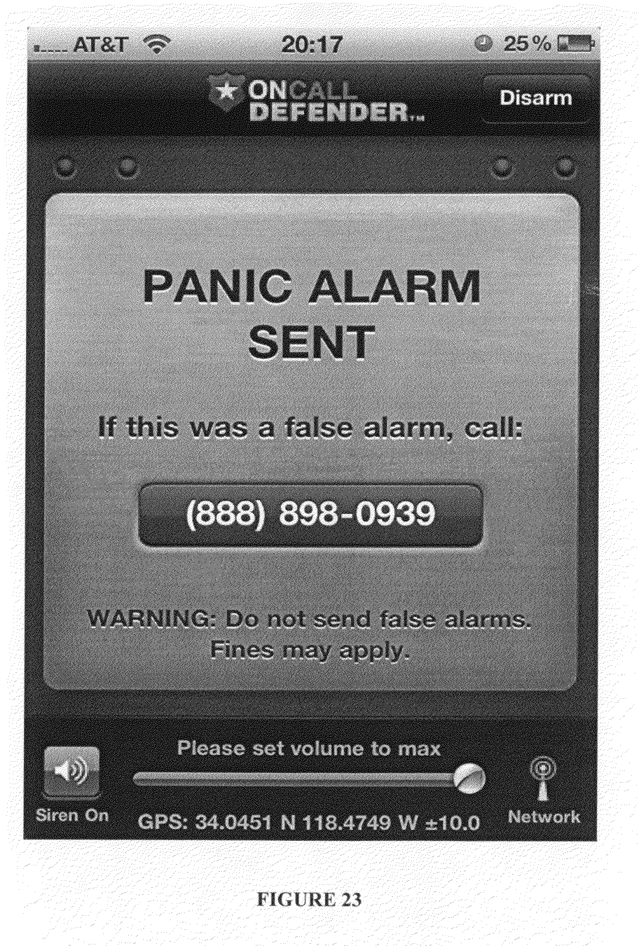

FIG. 23 is a screen shot of the mobile phone display on one embodiment of the invention and shows the PANIC ALARM SENT screen. This screen appears if a fired alarm is not canceled within 15 seconds.

When a false alarm is sent, the user can preferably press the button on the PANIC ALARM SENT screen, which will cause the phone to automatically call the central monitoring station for the user to report the false alarm. The user must give the answering central monitoring station operator the correct Safe Word in order to cancel the alarm and thus cancel having emergency response dispatched.

Preferably, the alarm alerts the user if there is no network connectivity. The alarm device notifies the user if the mobile network is not available, or if it drops out. Upon opening the alarm application, if the network is unavailable, a window opens with the following message:
Network Error
Unable to connect. Your device does not currently have a network connection. Please try again in a few moments.
   OK

Pressing OK takes the user to the Login screen.

When the alarm is armed, if the network connection is lost, an audible announcement commences:
“NO NETWORK. ALARM NOT MONITORED.”

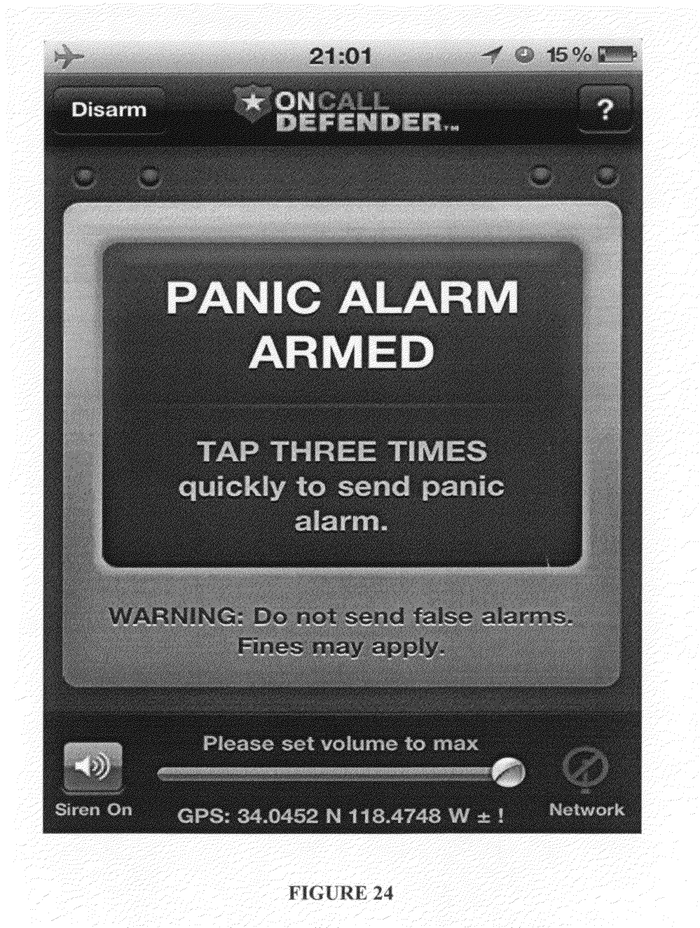

FIG. 24 is a screen shot of the mobile phone display on one embodiment of the invention and shows the PANIC ALARM ARMED screen with the network icon to the right of the volume slider in the “no network” notification configuration with animation ceased.

Upon reconnection of the network, an audible announcement commences:
“NETWORK RECONNECTED.”

Upon reconnection of the network, the network icon resumes animation.

Device Ring/Silent Switch Override. The phone incorporating the alarm, such as the iPhone®, incorporates a mechanical or software switch that toggles between speaker audio and silencing the speaker. The alarm can override the switch's Silent setting for all of the alarms audio, which includes the siren and network status announcements.

Preferably, the device also incorporates a medical alert alarm.

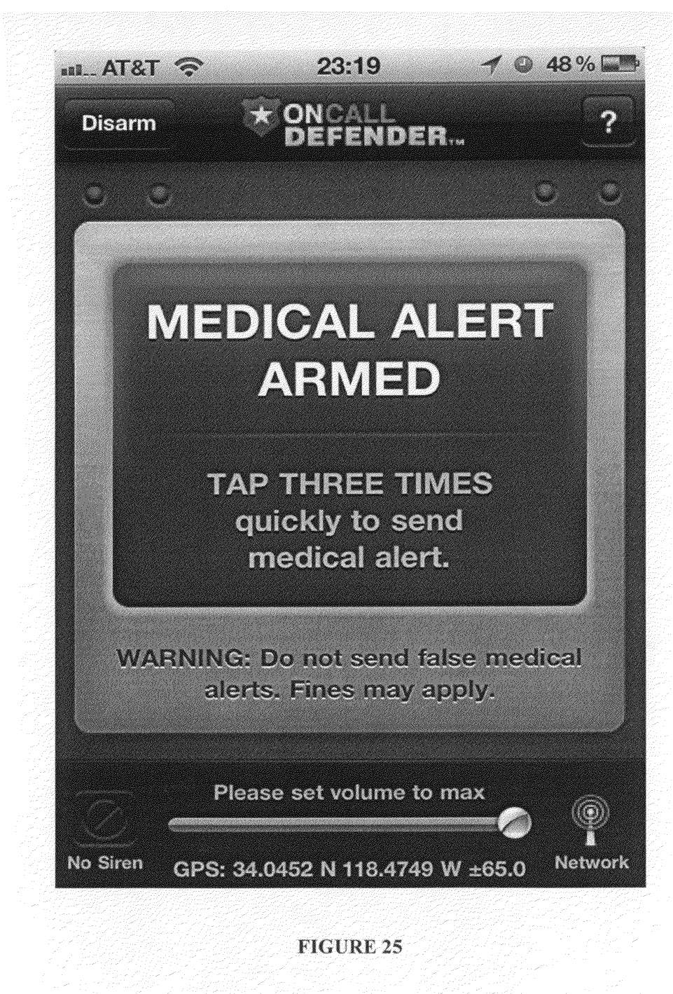

FIG. 25 is a screen shot of the mobile phone display of one embodiment of the invention and shows the medical alarm armed screen. The medical alert alarm incorporates the same “panic” alarm functionality of the standard emergency alarm, but also has the additional functionality of a “Medical Alert”. The armed screen layout, as shown in FIG. 24, is the same layout as the “panic” alarm functionality of the standard emergency alarm. The medical alert alarm button functions the same as the alarm button, that is tapping it three times quickly sends the medical alert. A preprogrammed amount of time, preferably 15 seconds, allows the user to disarm the medical alert alarm if it is false. Otherwise, after the 15 seconds, the same settings data and GPS location information is sent to a central alarm monitoring station. This information is preferably updated at a specific interval. Preferably, the user also adds important medical information to the settings so that the needs of the user can better be served.

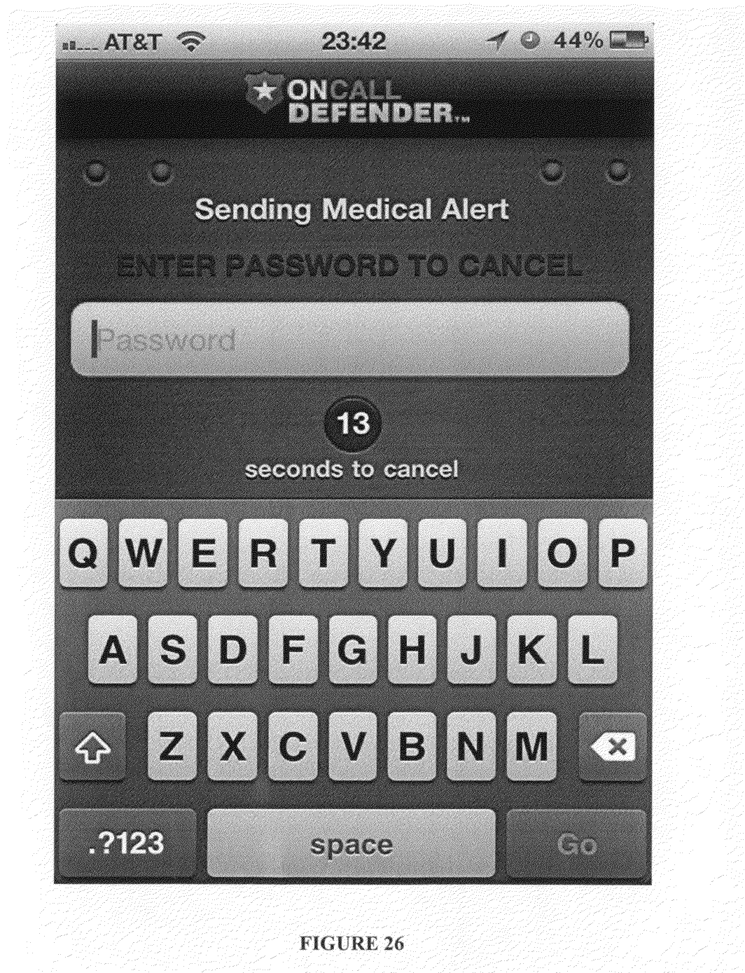

FIG. 26 is a screen shot of the mobile phone display of one embodiment of the invention and shows the medical alert ENTER PASSWORD TO CANCEL screen. The cancellation procedure is identical to the panic alarm cancellation procedure.

Upon sending a medical alert alarm, an audible announcement commences:
“MEDICAL ALERT SENT.”

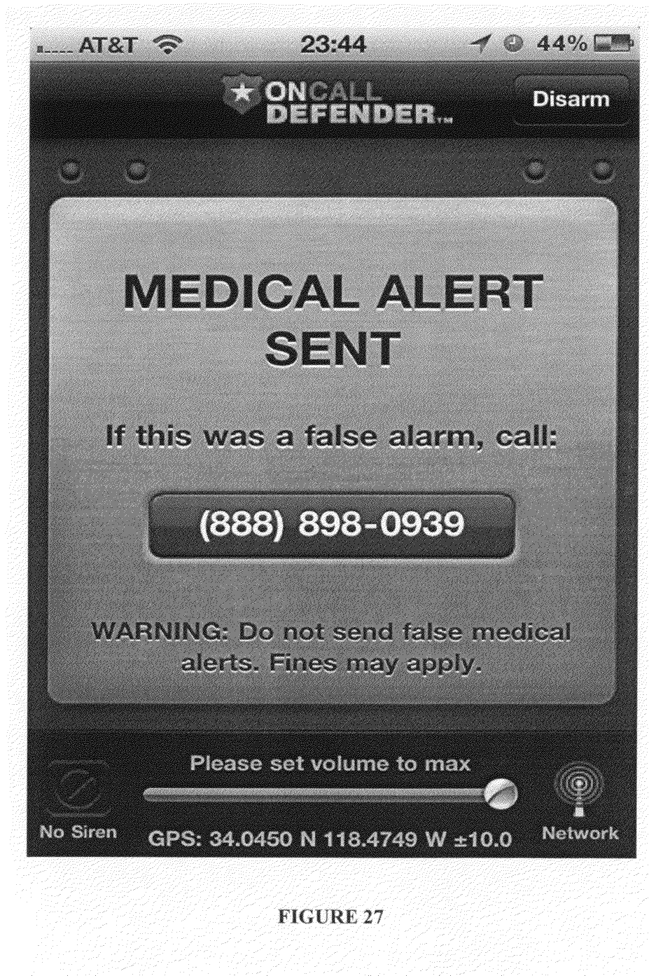

FIG. 27 is a screen shot of the mobile phone display of one embodiment of the invention and shows the MEDICAL ALERT SENT screen.

Entering the user password in the first 15 seconds after a medical alert alarm is sent cancels the alarm, and a window opens with the following message:
Cancelled
The Medical Alert has been successfully cancelled.
   OK

Pressing OK returns the user to the Arm, Test, Location Notes, Settings, Auto-Arm screen.

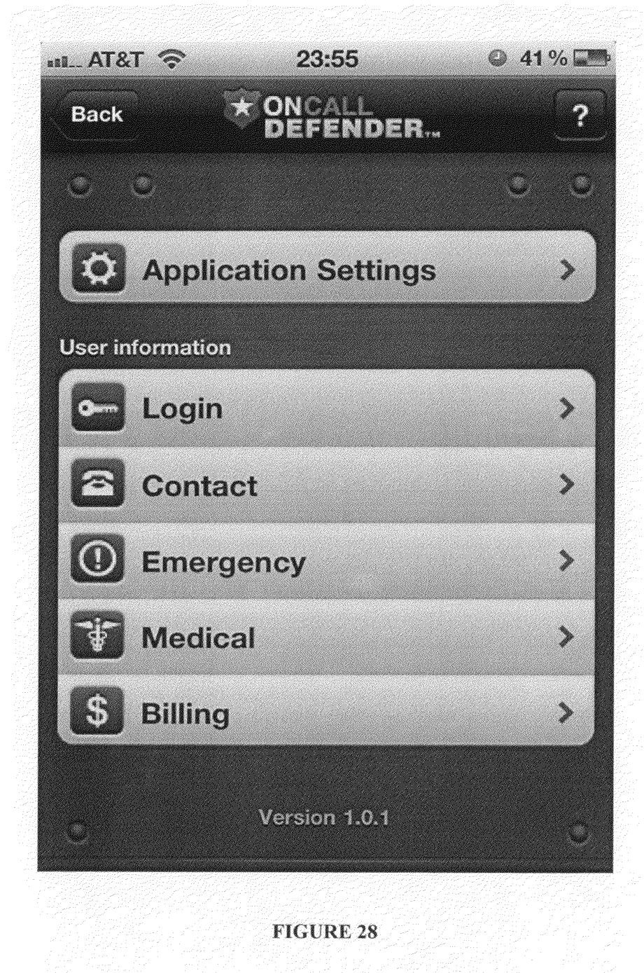

FIG. 28 is a screen shot of the mobile phone display of one embodiment of the invention and shows the medical alert Application Settings, Login, Contact, Emergency, Medical, Billing screen.

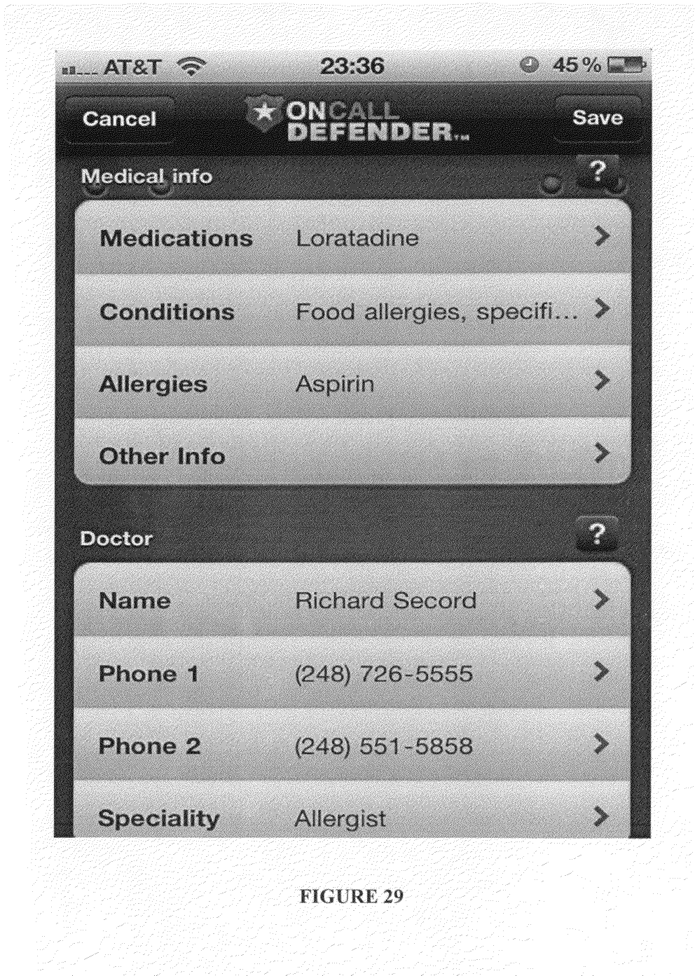

FIG. 29 is a screen shot of the mobile phone display of one embodiment of the invention and shows the medical alert alarm Medical information screen. Medical information fields include Medications, Conditions, Allergies, and Other Info. Doctor fields include Name, Phone 1, Phone 2, and Specialty.

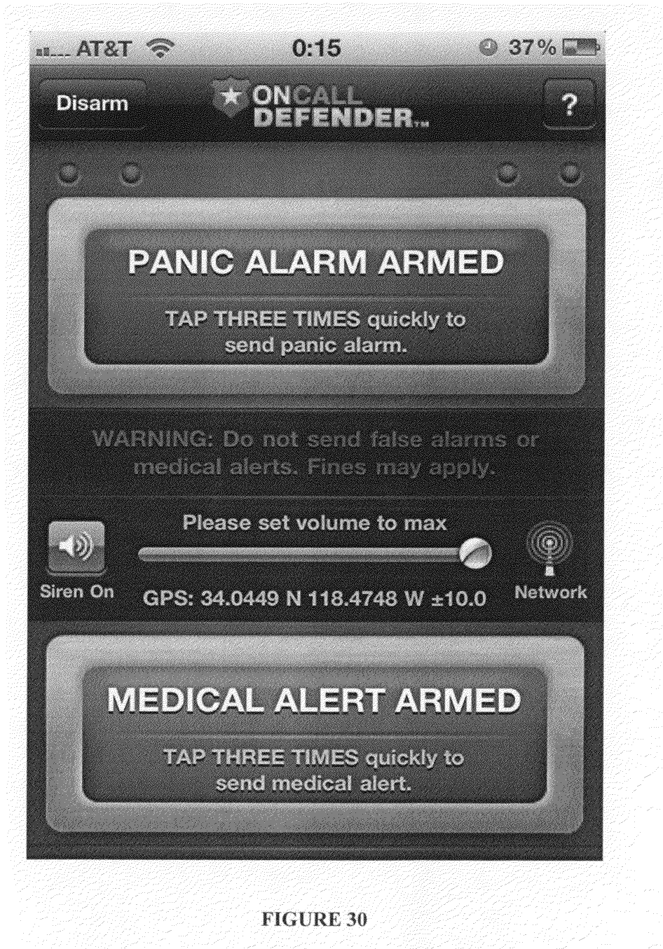

FIG. 30 is a screen shot of the mobile phone display of one embodiment of the invention and shows the panic alarm and medical alert alarm combined Arm screen.

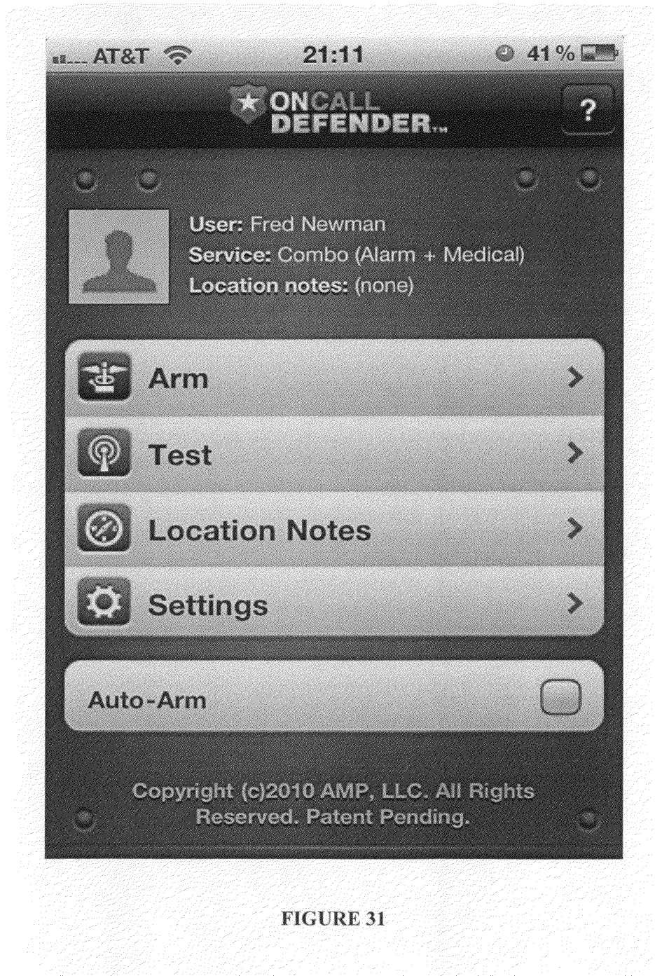

FIG. 31 is a screen shot of the mobile phone display of one embodiment of the invention and shows the combined panic alarm and medical alert Arm, Test, Location Notes, Settings, and Auto-Arm screen.

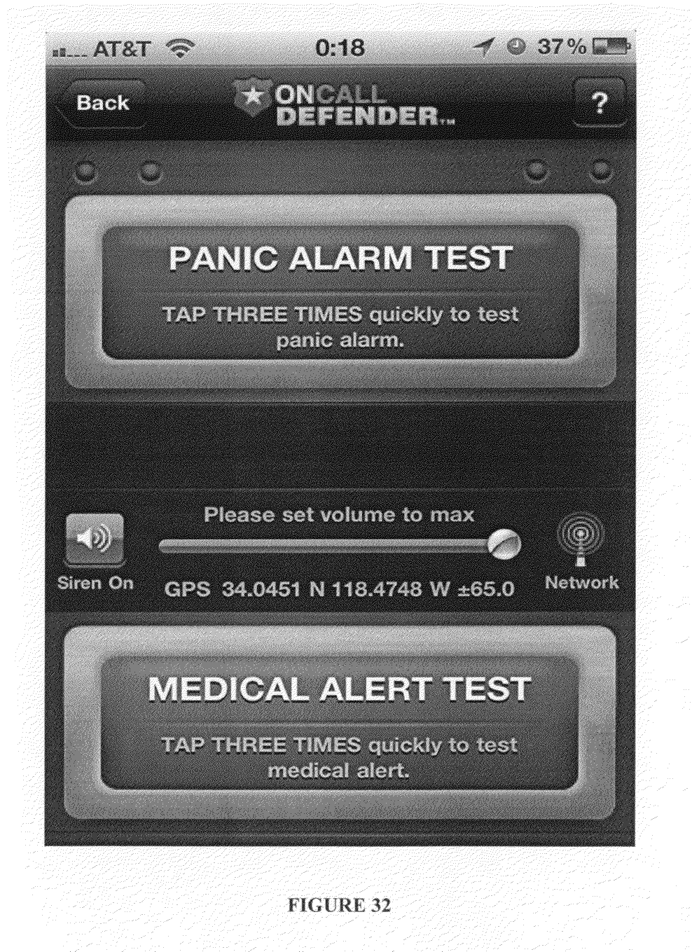

FIG. 32 is a screen shot of the mobile phone display of one embodiment of the invention and shows the combined panic alarm and medical alert Test screen.

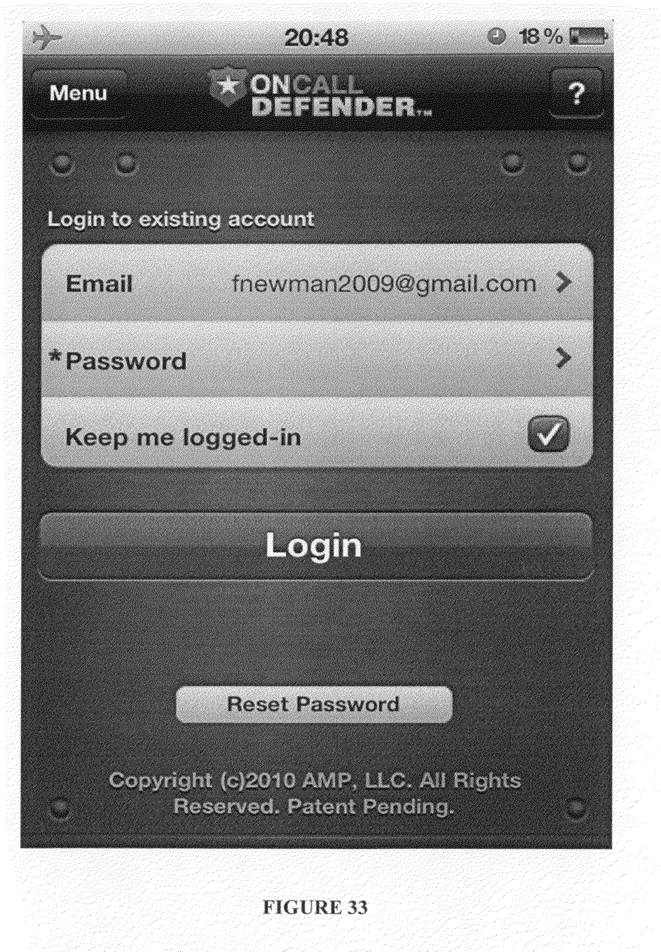

FIG. 33 is a screen shot of the mobile phone display of one embodiment of the invention and shows the Reset Password button. Pressing the Reset Password button takes the user to the Reset Password screen.

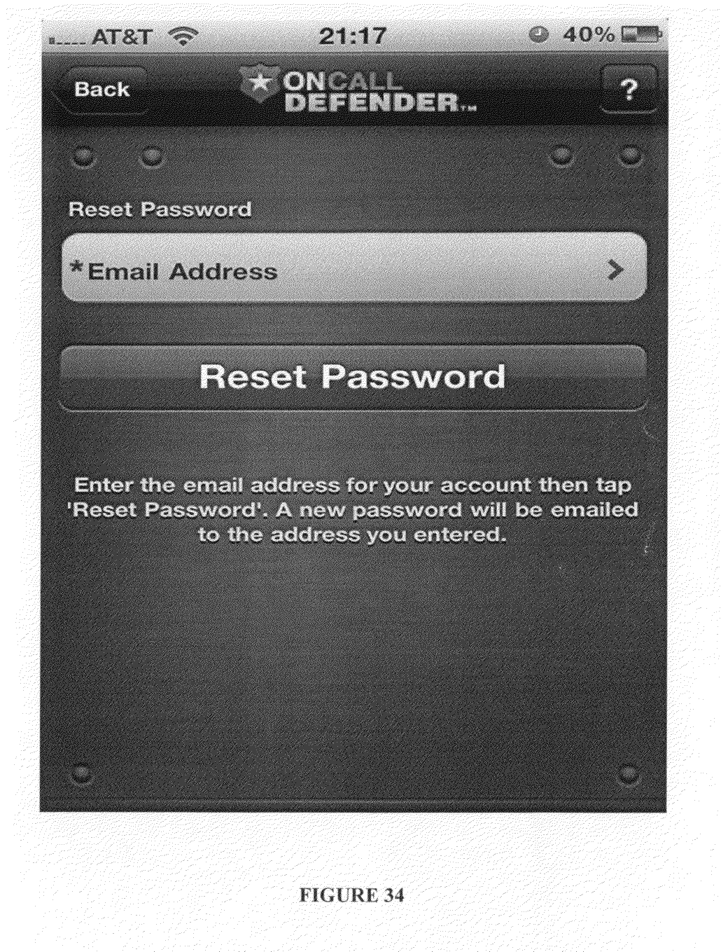

FIG. 34 is a screen shot of the mobile phone display of one embodiment of the invention and shows the Reset Password screen. If a password is forgotten by the user, by entering the email address of the account and pressing Reset, a new password is reset to a random value and emailed to the entered account email address. A new password can then be chosen. (See FIG. 6)

Preferably, the alarm phone device includes additional optional features.

Moreover, the device may be set to automatically take and send photos to the central alarm monitoring station. This will allow the central alarm monitoring station and first responders to view, if there is appropriate light on the victim, scene, or perpetrator of the crime. Preferably, these photos are emailed or otherwise transmitted to the central alarm monitoring station. These photos can be used to support prosecution of the perpetrator.

In addition, the alarm may incorporate an automatic transmission of live video upon firing the alarm. This preferably constitutes live video streaming to the central alarm monitoring station from the scene of the crime for critical information regarding the incident, identification of suspects, and support of prosecution.

Other features may include: 1) automatic video recording in segments and transmission of resulting video files to a preset email address; 2) automatic transmission of live two way audio between the device and the alarm monitoring station; 3) automatic recording of audio in segments and transmission of resulting audio files to a preset email address; 4) upon alarm, in addition to the alarm or medical alert data sent to the alarm monitoring station, a user pre-programmed text message is automatically sent to user pre-programmed telephone numbers identifying that the user has sent an alarm to the alarm monitoring station for police or medical alert response (the text preferably includes the GPS location of the phone and an updated location is sent by text message periodically to the pre-programmed telephone numbers); and 5) upon alarm, after the alarm data is sent to the alarm monitoring station, a user pre-programmed phone number is automatically called with a user pre-recorded message played upon connection notifying the recipient that the user is in trouble (the message also preferably includes a GPS location and the call is repeated periodically with updated GPS location information).

Horizontal and vertical distance from where the application was turned on is also reported to the monitoring station in the event of an alarm or medical alert, which will show along with GPS location/address to inform the monitoring company that the user is no longer at the Location Notes location, in the event the user does not cancel or change the Location Notes entered information.

“Location Notes function with audio capability, whereby the user can speak her location in a building into the phone's microphone, populating an audio file with the information, that will be sent to the monitoring station in the event of a medical alert or panic alarm.

What is claimed is:

1. A mobile alarm phone comprising:
a mobile phone;
wherein said mobile phone comprises an alarm; and
wherein said alarm is operated using said mobile phone controls.

2. The mobile alarm phone of claim 1, wherein said alarm transmits an alert to a central alarm monitoring station when said alarm is fired;
wherein said central alarm monitoring station has a first responder dispatched to a location of said mobile phone.

3. The mobile alarm phone of claim 2, wherein a user provides said alarm with a plurality of settings data;
wherein said alarm transmits said plurality of settings data to said central alarm monitoring station;
wherein said phone further comprises a global positioning system;
wherein said alarm transmits said location of said mobile phone based on said global positioning system.

4. The mobile alarm phone of claim 3, wherein said alarm transmits an updated location on a preset interval.

5. The mobile alarm phone of claim 4, wherein said alarm emits an audible alarm;
wherein said audible alarm may be toggled to a silent position.

6. The mobile alarm phone of claim 5, wherein said alarm is activated by arming said alarm and then firing said alarm.

7. The mobile alarm phone of claim 6, wherein said alarm is fired by pushing an alarm button after said alarm is armed.

8. The mobile alarm phone of claim 7, wherein said user may cancel said fired alarm.

9. The mobile alarm phone of claim 7, wherein said alarm transmits live audio or video from said mobile phone.

10. The mobile alarm phone of claim 7, wherein said alarm transmits recorded audio or video from said mobile phone.

11. The mobile alarm phone of claim 7, wherein said alarm transmits a photo of said user.

12. The mobile alarm phone of claim 7, wherein said alarm notifies said user if said phone is not connected to a network or otherwise has no signal or connectivity.

13. The mobile alarm phone of claim 7, wherein said alarm includes false alarm avoidance features.

14. The mobile alarm phone of claim 7, wherein the alarm includes a medical alert alarm.
